(19) United States
(12) Patent Application Publication
(10) Pub. No.: US 2015/0150047 A1
(43) Pub. Date: May 28, 2015

(54) OPTIMIZING MOBILE CONTENT BASED ON USERS STATE OF MOTION

(71) Applicant: POINT INSIDE, INC., Bellevue, WA (US)

(72) Inventor: Jonathan A. CROY, Bellevue, WA (US)

(21) Appl. No.: 14/609,212

(22) Filed: Jan. 29, 2015

Related U.S. Application Data
(62) Division of application No. 13/656,566, filed on Oct. 19, 2012.
(60) Provisional application No. 61/550,283, filed on Oct. 21, 2011.

(51) Int. Cl. H04N 21/258; H04N 21/414; H04N 21/45; H04N 21/61; H04N 21/81; G06Q 30/02; H04N 21/2668

(52) U.S. Cl. CPC H04N 21/25841; G06Q 30/0267; G06Q 30/0261; H04N 21/41407; H04N 21/2668; H04N 21/6131; H04N 21/812; H04N 21/25891; H04N 21/4524; H04N 21/4532
USPC 725/34; 705/14.64; 705/14.58

(57) ABSTRACT

A method and system selects advertisements based on data regarding a user's behavioral patterns, such as the user's broadcast viewing history, current state of motion, and location, interests, and intentions.

### CROSS-REFERENCE TO RELATED APPLICATION

This application claims the benefit of and incorporates by this reference U.S. patent application Ser. No. 61/550,283 filed 2011 Oct. 21 and U.S. patent application Ser. No. 13/656,566 filed 2012 Oct. 19; this application is a divisional of U.S. patent application Ser. No. 13/656,566.

### FIELD OF THE INVENTION

The present invention relates generally to mobile advertising, and more particularly, to correlating a user's behavioral patterns (e.g. a user's broadcasting viewing history, current state of motion, location, interests and intentions) to determine the most effective mobile advertising strategy.

### SUMMARY OF THE INVENTION AND BACKGROUND INFORMATION

The following description includes a summary of certain aspects of the present disclosure as well as information that may be useful in understanding the present invention. It is not an admission that any of the information provided herein is prior art or relevant to the presently claimed invention, or that any publication specifically or implicitly referenced is prior art.

Advertising is an effective way of communicating, encouraging and persuading an audience to make a specific action; i.e. to drive the behavior of the consumer towards a desired result. Advertising can be disseminated in various forms ranging from television commercials to products or brands being embedded in entertainment and media. Television commercials are considered to be the most effective mass-market advertising format which is reflected in the high prices companies pay for advertising time.

With the advent of the smartphone, a new means of communicating with millions of consumers can and has already begun to be realized. With the number of smartphone users ever increasing, advertisers are intensifying their efforts in mobile advertising. In some markets, the most commonly seen types of advertising are Mobile Web Banners (top of page) and the Mobile Web Poster (bottom of page banner). In others, it is dominated by SMS advertising (which has been estimated at over 90% of mobile marketing revenue worldwide). Other forms include MMS advertising, advertising within mobile games and mobile videos, during mobile TV receipt, full-screen interstitials, which appear while a requested item of mobile content or mobile web page is loading up, and audio advertisements that can take the form of a jingle before a voicemail recording, or an audio recording played while interacting with a telephone-based service such as movie ticketing or directory assistance.

As mobile advertising is still in its infancy, there is still room to develop not only new advertising strategies, but improve the efficiency of current mobile advertising. Currently, the mobile advertising content that is displayed to any given consumer's mobile device is determined by either recommendations based on the consumer's current activity or randomly chosen advertisements with no current bearing on the consumer's activity. However, other pertinent information can be used to help determine the appropriate type of advertising to be displayed on a consumer's mobile device. Of particular relevance, is a user's broadcast viewing history (advertisements seen while watching television), current state of motion (walking, driving, riding a bus, etc.), and their current location, interests and intents (specific actions taken by a mobile user such as self declaration, searching for a product and adding that product to a shopping list).

As regards a user's broadcast viewing history, a consumer's broadcast viewing history, i.e. the advertisements that they viewed while watching television, can be used as a means to determine that same consumer's advertising on their mobile device. For example, a television viewer recently watched a television show via a network that tracked commercials distributed to the node that they watched the show on. These commercials were for items that could be purchased in the physical world like grocery items (Pepsi Cola, Honey Nut Cheerios, Budweiser, Tostitos Corn Chips, Pace Salsa, Toyota Cars, etc.). Afterwards, a person present in the home who watched one of these commercials is out of the home with their mobile phone. A service running on the phone or running on a remote network that chooses and/or delivers content to the mobile device, could query a database to find out what content was recently viewed. If determined relevant to the mobile user, the service could find messages to reinforce commercial messages that were previously viewed. For example, if the mobile user is shopping, messages from Pepsi could be delivered to make sure the user keeps Pepsi top of mind. These messages (delivered at-home and in-store) could be part of an orchestrated campaign or unrelated to each other aside from the relationship of being the same advertiser. Another option would be to allow a competitive option (e.g., Coke) vie for the mobile users mindshare by opening up the opportunity for them to reach the same user with the knowledge that said user was subject to an at-home campaign from a competitor (e.g., Pepsi).

As regards a user's state of motion, presenting mobile content in a manner that accommodates the user's current state of motion, be it walking or driving, would be extremely beneficial in ensuring that the user's attention is not solely engaged with their mobile device during various activities. For example, a mobile device would report to a server a complete set of location results (e.g., GPS results including position, altitude, accuracy, vector, velocity) and other sensory data (e.g, accelerometer) that could be combined to determine if the user is stationary (e.g., GPS vector indicates insignificant movement and accelerometer indicates the user is not walking) If the user is stationary, the content delivered to the phone would be optimized for this scenario (e.g., provide access to deeper content, text-based content or rich media that can be consumed more easily while stationary). If the location results and sensory data indicated that the user may be walking (e.g., GPS vector indicates insignificant or slow movement and sensory data indicates a walking motion), the content delivered to the phone would be optimized for consumption by a user who is walking (e.g., provide access to information that can be easily consumed while walking such as data that is visually brief and compelling).

Finally as regards a user's current location, interests and intents, the content of the mobile message can be selected or refined based on the user's location combined with user interest and intents that have been captured on the mobile device during the current session or from previous sessions. For example, a mobile device user begins a mobile session (i.e. a discreet event or action taken by the user, e.g. opening and using a mobile application), that is associated with a point in time (date and time) and the user's location (generated through a variety of methods; e.g. GPS). Within this mobile session, the user takes specific actions that reveal the user's interests (e.g. searching for a particular product) and their intent (e.g. adding a specific product to a shopping list or viewing a map to determine where to pick that particular product up). By correlating these aspects of the user's behavioral patterns with one another, a service running either on the phone or remotely would then determine which content is the most relevant to the user to then be displayed.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 illustrates a block diagram of the consumer specific mobile advertising system as regards broadcast viewing history according to an embodiment of the present invention;

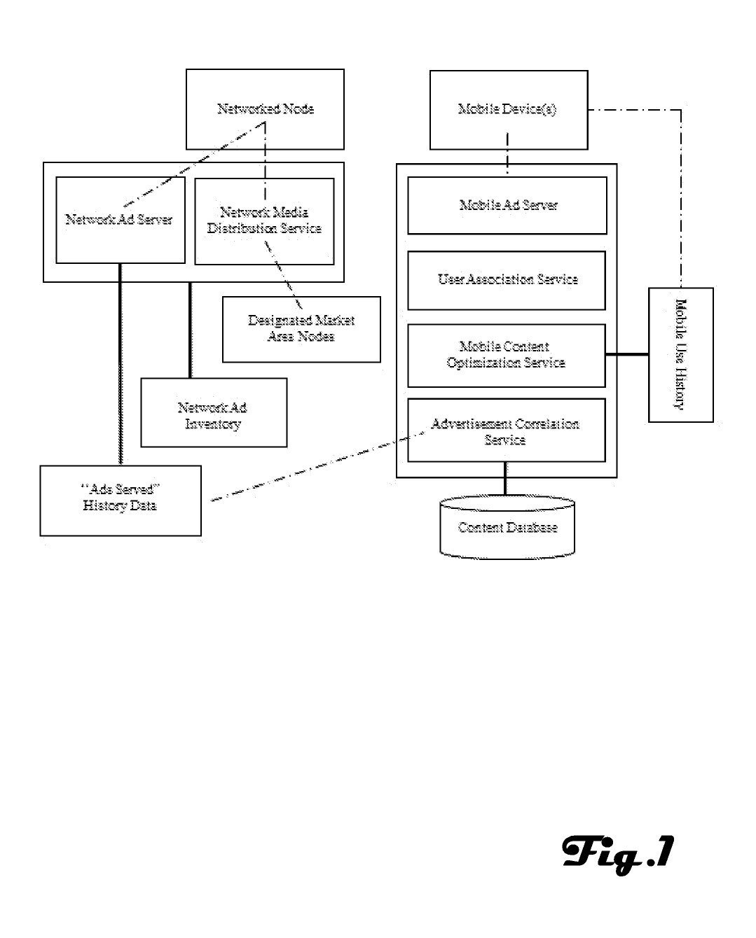

FIG. 2 illustrates a block diagram of the consumer specific mobile advertising system as regards user state of motion according to an embodiment of the present invention;

FIG. 3 illustrates a block diagram of the consumer specific mobile advertising system as regards user location/interest/intention according to an embodiment of the present invention.

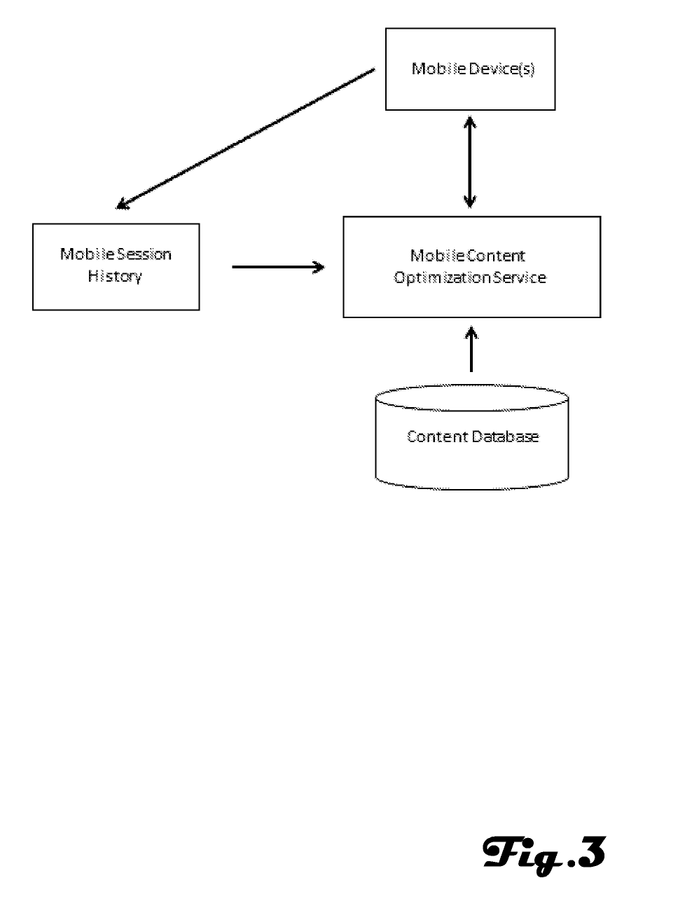

FIG. 4 is a functional block diagram of an exemplary computing device and some data structures and/or components thereof.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention are directed toward advertisement correlation for use in consumer specific mobile advertising. In a first embodiment described herein with reference to FIG. (1), correlating broadcast viewing history for consumer-specific mobile advertising may be done using an “ads served” history database in conjunction with an advertisement correlation application, and is referred to as consumer-unique advertisement correlation. The embodiment of a consumer-unique advertisement correlation system 100 is shown in FIG. (1). In this embodiment, the system 100 is configured for operative communication with a plurality of radio frequency (RF) devices, such as a wireless device 110, and with one or more media networks, such as a cable or satellite network node 105.

As shown in FIG. (1), the system 100 comprises a plurality of applications or “modules” executable on one or more computers, such as one or more servers, one or more wireless devices 110, or any combination thereof. It should be appreciated that the various modules of the system 100 may be logically or physically implemented and/or combined in a plurality of ways, and that the invention in not limited to the particular arrangement shown in FIG. (1). Each of the various modules of the system 100 is described below.

The system 100 comprises a mobile user advertisement optimization module 120 configured for correlating multiple advertising content types to provide a user-unique mobile advertisement service. To do so, this module 120 comprises four distinct services: a user association service 165, an advertisement correlation service 175, a mobile user content optimization service 170 and a mobile ad server 160. The user association service 165 is configured for associating a specific user with both their broadcast viewing history as well as their mobile device. The advertisement correlation service 175 is configured for correlating the “ads served” history data 130 of a given user with an advertisement from the mobile ad inventory 125. The advertisement correlation service 175 chooses the appropriate mobile advertisement based on the criteria provided by the mobile user content optimization service 170. The mobile user content optimization service 170 is configured for incorporating mobile use history, e.g. a user's current session (location, interests, intents), with the advertisements suggested by the ad correlation service 175. Finally, the mobile ad server 160 is configured to deliver the advertisements that have been generated by the above three services to the mobile device.

The system's 100 ability to accurately generate user-specific mobile advertisement based on broadcast viewing history is predicated upon access to the broadcast viewing history, i.e. the “ads served” history data 130, of that user. The “ads served” history database 130 contains all of the advertisements that have been displayed to the user over any given network ad server 150. The network ad server 150 provides these advertisements for insertion into a broadcast message from a network advertisement inventory 135 and can also be in response for an advertisement from a specific network node 105, e.g. cable/satellite television set-top box. The content database 125 itself accumulates advertising from a network media distribution service 155 that provides varying modes of media distribution including broadcasts and multicasts based on guidelines from relevant designated market area nodes 145. Thus, taken together, these services are able to provide an accurate viewing history for any given user for purposes of correlation with other forms of advertisement.

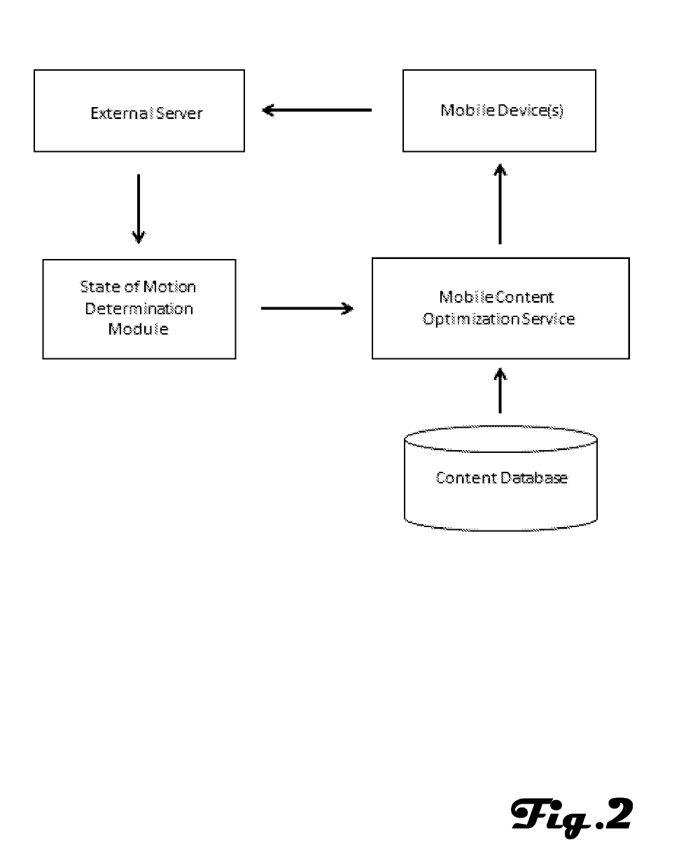

In a second embodiment described herein with reference to FIG. 2), correlating a user's current state of motion for consumer-specific mobile advertising may be done using a state of motion determination module in conjunction with a mobile content optimization module, and is referred to as consumer-unique advertisement correlation. The embodiment of a consumer-unique advertisement correlation system 200 is show in its current embodiment in FIG. (2). In this embodiment, the system 200 is configured for operative communication with a plurality of mobile devices as well as a plurality of external servers.

As shown in FIG. (2), the system 200 comprises a plurality of applications or “modules” executable on one or more computers, such as one or more servers, one or more wireless devices 210, or any combination thereof. It should be appreciated that the various modules of the system 200 may be logically or physically implemented and/or combined in a plurality of ways, and that the invention in not limited to the particular arrangement shown in FIG. (2). Each of the various modules of the system 200 is described below.

The system comprises a state of motion determination module 285 configured for determining the mobile device user's current state of motion. Through communication with an external server 280 the module gathers location data (e.g. GPS results including position, altitude, accuracy, vector, velocity) and other sensory data (e.g. accelerometer) to determine whether or not the user is either stationary or in motion.

The system also comprises a mobile content optimization module 270 configured for determining the optimal content to be delivered to the mobile device in relation to the state of motion determined by the state of motion determination module 285. If the state of motion determination module's 285 output indicates that the user is driving, the mobile content optimization module 270 will deliver tailored content for consumption by a user who is driving (e.g. provide access to information that can be easily consumed, such as data that is visually brief). The mobile content delivered to the mobile device user is stored in a content database 225 from which the mobile content optimization module 270 draws the appropriate content.

The system 200 also comprises a content database module 225 configured for storing the advertiser's content and information as it is generated. The messages can include a variety of content (text, audio, promotions) which must be stored and constantly updated. The mobile content optimization service 270 pulls appropriate content from the database module 225 for display on the user's mobile device.

In a third embodiment described herein with reference to FIG. (3), correlating a user's current location, interests and intentions for consumer-specific mobile advertising may be done using a mobile session history module in conjunction with a mobile content optimization module, and is referred to as consumer-unique advertisement correlation. The embodiment of a consumer-unique advertisement correlation system 300 is show in its current embodiment in FIG. (3). In this embodiment, the system 300 is configured for operative communication with a plurality of mobile devices.

As shown in FIG. (3), the system 300 comprises a plurality of applications or “modules” executable on one or more computers, such as one or more servers, one or more wireless devices 310, or any combination thereof. It should be appreciated that the various modules of the system 300 maybe logically or physically implemented and/or combined in a plurality of ways, and that the invention in not limited to the particular arrangement shown in FIG. (3). Each of the various modules of the system 300 is described below.

The system comprises a mobile session history module 390 configured for logging a user's current mobile session. Through communication with a plurality of mobile devices 310 the module gathers information such as the user's location as well as the specific actions taken by the user (e.g. searching for a particular product or service) to store for future correlation with applicable mobile content. This module 390 is also configured for storing past mobile session history per user.

The system also comprises a mobile content optimization module 370 configured for determining the optimal content to be delivered to the mobile device in relation to the user's location/interests/intentions determined by the mobile session history module 390. If the mobile session history module's 390 output indicates that the user is currently located within a particular grocery store and just asked for directions to a particular item in said grocery store, the mobile content optimization module 370 will deliver relevant content; e.g. content as regards others items in that particular grocery store. The mobile content delivered to the mobile device user is stored in a content database 325 from which the mobile content optimization module 370 draws the appropriate content.

The system 300 also comprises a content database module 325 configured for storing the advertiser's content and information as it is generated. The messages can include a variety of content (text, audio, promotions) which must be stored and constantly updated. The mobile content optimization service 370 pulls appropriate content from the database module 325 for display on the user's mobile device.

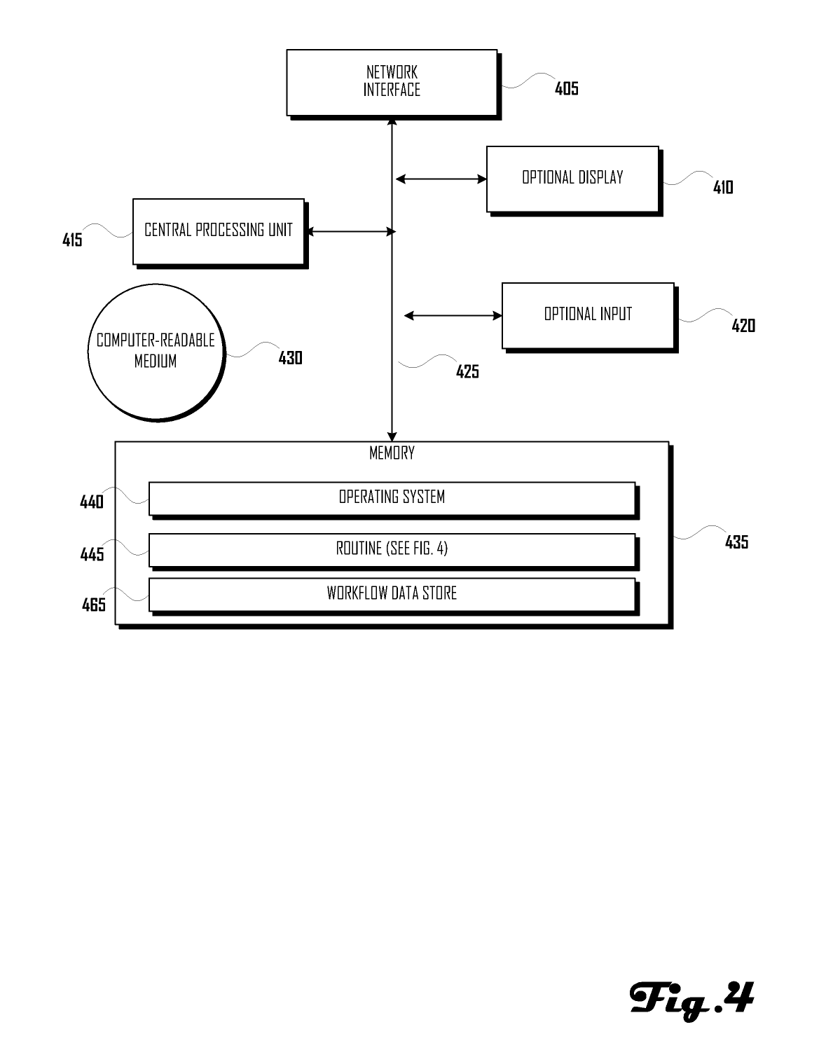

FIG. 4 is a functional block diagram of an exemplary computing device, in which the modules discussed above may be implemented. In some embodiments, the computing device (400) may include many more components than those shown in FIG. (4). However, it is not necessary that all of these generally conventional components be shown in order to disclose an illustrative embodiment. As shown in FIG. (4), the computing device (400) includes a network interface (405) for connecting to a network, such as the Internet.

The computing device (400) also includes at least one processing unit (415), memory (435), and an optional display (410), all interconnected along with the network interface (405) via a bus (425). The memory (435) generally comprises a random access memory (“RAM”), a read only memory (“ROM”), and a permanent mass storage device, such as a disk drive or SDRAM (synchronous dynamic random-access memory). The memory (435) stores program code for software modules, such as, for example, the modules discussed above. In addition, the memory (435) also stores an operating system (440). These software components may be loaded from a non-transient computer readable storage medium (430) into memory (435) of the computing device (400) using a drive mechanism (not shown) associated with a non-transient computer readable storage medium (430), such as a floppy disc, tape, DVD/CD-ROM drive, memory card, or other like storage medium. In some embodiments, software components may also or instead be loaded via a mechanism other than a drive mechanism and computer readable storage medium (430) (e.g., via network interface (405)).

The computing device (400) may also comprise hardware supporting optional input modalities, Optional Input (420), such as, for example, a touchscreen, a keyboard, a mouse, a trackball, a stylus, a microphone, a GPS unit, and a camera.

Computing device (400) also comprises or communicates via bus (425) with data store (465). In various embodiments, bus (425) may comprise a storage area network (“SAN”), a high speed serial bus, and/or via other suitable communication technology. In some embodiments, computing device (400) may communicate with data store (465) via network interface (405).

1. A method for optimizing the relevance of mobile content based on user behavioral patterns performed in a computer comprising a memory, the method comprising:
with a user association service module, associating a user with a broadcast viewing history for the user and a mobile device of the user;
with an advertisement correlation service module, choosing a subset of mobile advertisements from a content database based on a history of advertisements served to the user;
the content database comprising a plurality of mobile advertisements;
with a mobile user content optimization service module, obtaining the user's then-current mobile device session history and correlating the then-current mobile device session history with at least one advertisement in the subset of advertisements; and
with a mobile ad server, delivering to the mobile device the at least one advertisement from the ad correlation service module.

2. The method according to claim 1, wherein the broadcast viewing history for the user is a broadcast viewing history relative to a location where the user obtains content via a set-top box.

3. The method according to claim 2, wherein the broadcast viewing history for the user comprises advertisements served to the set-top box, which advertisements are tracked by a broadcast network which broadcast network provides content to the set-top box.

4. The method according to claim 3, wherein the broadcast network is one of a cable broadcast network and a satellite broadcast network.

5. The method according to claim 1, wherein the mobile user content optimization service module determines that the then-current mobile device session history comprises at least one of a location, interest, and intention and correlates the then-current mobile device session history with at least one of the plurality of advertisements from the ad correlation service module based on the at least one of a location, interest, and intention.

6. The method according to claim 5, wherein the mobile user content optimization service module determines the location based on information from a GPS unit in the mobile device, determines the interest based on the user searching for a product, and determines the intention based on the user adding a product to a shopping list or viewing a map to determine where to pick a product up.

7. The method according to claim 5, wherein the mobile user content optimization service module selects an advertisement which either reinforces or competes with an advertisement from the broadcast viewing history for the user.

8. A computer system with a computer readable medium comprising instructions which, when executed, perform a method comprising:
with a user association service module, associating a user with a broadcast viewing history for the user and a mobile device of the user;
with an advertisement correlation service module, choosing a subset of mobile advertisements from a content database based on a history of advertisements served to the user;
the content database comprising a plurality of mobile advertisements;
with a mobile user content optimization service module, obtaining the user's then-current mobile device session history and correlating the then-current mobile device session history with at least one advertisement in the subset of advertisements; and
with a mobile ad server, delivering to the mobile device the at least one advertisement from the ad correlation service module.
